(19) United States
(12) Patent Application Publication
(10) Pub. No.: US 2016/0316499 A1
(43) Pub. Date: Oct. 27, 2016

(54) IDENTIFICATION OF A BROADBAND CONNECTION

(71) Applicant: Ford Global Technologies, LLC, Dearborn, MI (US)

(72) Inventor: Hanan Ahmed, Belleville, MI (US)

(73) Assignee: Ford Global Technologies, LLC, Dearborn, MI (US)

(21) Appl. No.: 14/696,593

(22) Filed: Apr. 27, 2015

(51) Int. Cl. H04W 76/02; H04L 29/08; H04W 88/16; H04W 8/00; H04W 12/06

(52) U.S. Cl. CPC H04W 76/023; H04W 8/005; H04W 12/06; H04W 88/16; H04L 67/12

(57) ABSTRACT

A computer in a vehicle communication head unit is configured to operate a communication network. The computer further configured to broadcast a connection type or responds with this information upon request. The computer may also use Access Network Query Protocol (ANQP) message over Generic Advertisement Service (GAS) and receive a communication network connection type message from a wireless device. The computer will access a vehicle communication head unit profile, including a communication network connection type to an external network and notify the wireless device the communication network connection type. The computer then receives a notification message from the wireless device that the communication network connection type meets a criteria of the wireless device and engage in a wireless data communication session with the wireless device and the vehicle communication head unit.

### BACKGROUND

Mobile devices, such as smartphones or tablets, typically have the capability to connect to the Internet via mobile networks. Theses mobile networks generally include a wireless network distributed over land areas, called cells, and each cell is served by at least one fixed-location transceiver, known as a cell site or base station. In a mobile network, each cell uses either a different set of frequencies or a different set of pseudo-random codes to prevent neighboring cells from interfering with each other.

Today's vehicles often have the capability to connect to the Internet via mobile networks, such as a cellular network or alternatively, a satellite network or a dedicated mobile high speed radio network. A vehicle can then offer Internet access to devices within the vehicle via a vehicle's Wireless Local Area Network (WLAN) hotspot, thereby potentially saving the user's mobile data, battery power and money. The vehicle's WLAN may also connect to the Internet with a faster and more reliable connection than would otherwise be available to a user's mobile device. However, in some instances, the hotspot's connection data rate may be actually slower and less reliable than the user's own mobile data connection, the cost may be higher, there is a data limit, the connection is undesirable because it may introduce additional delay such as satellite, or it is another Wi-Fi connection to an AP which then connects to the Internet.

### BRIEF DESCRIPTION OF THE DRAWINGS

FIG. 1 is a block diagram of an example of a vehicle's head unit access point.

FIG. 2 is a block diagram of an exemplary head unit system and computer.

FIG. 3 Is a flowchart of an exemplary querying process of an access point.

FIG. 4 is flowchart of a wireless device evaluating a broadband connection type

FIG. 5 is flowchart diagram similar to FIG. 4, but includes further examination of the broadband connection type while the mobile device is connected to the head unit.

### DETAILED DESCRIPTION

With reference to the Figures, wherein like numerals indicate like parts throughout the several views, a head unit 22 is positioned in a vehicle (not shown) to provide network 14 access to the vehicle, e.g., access to the Internet. The vehicle can use network 14 access for many purposes, e.g., to update mapping software, stream or download music, run user applications or even to send a detected vehicle fault, vehicle health, statistical information, usage information to the vehicle's manufacturer or other remote service center, personal health information and critical health events and other user authorized information to relevant servers.

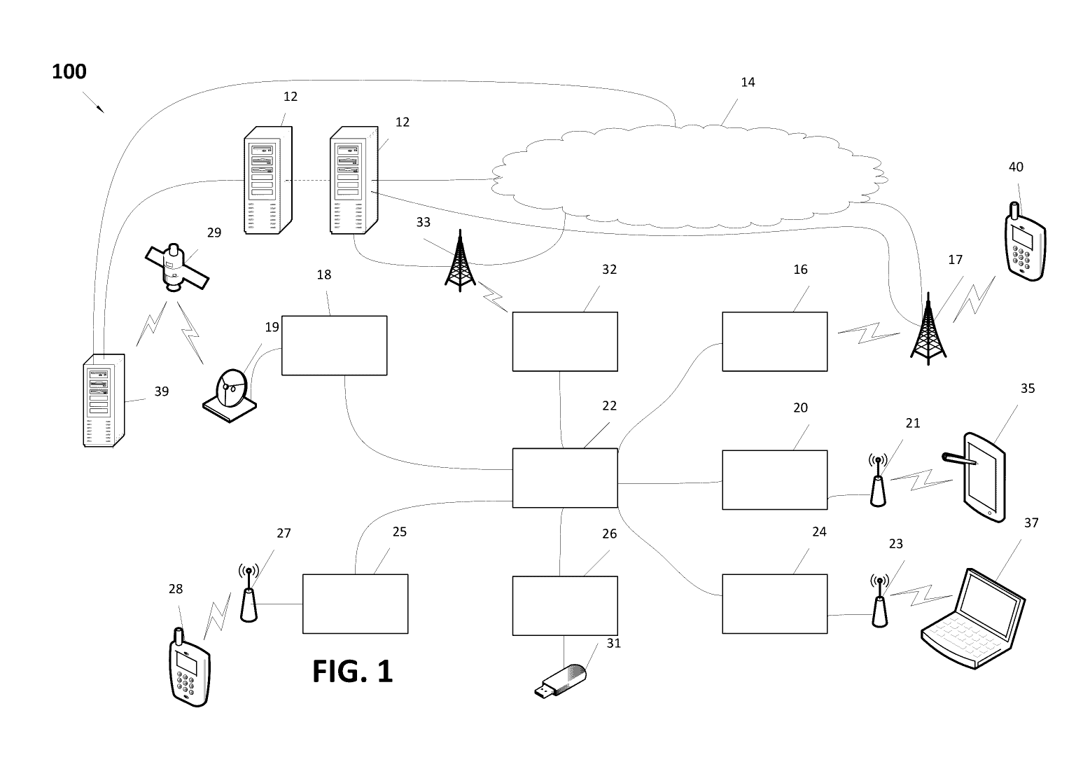

FIG. 1 is a block diagram of an exemplary broadband connectivity system 10 that includes a head unit 22 with one or more interfacing gateways, e.g., a Wi-Fi gateway 20, a Bluetooth gateway 24, a USB gateway 26 and a near field communication (NFC) gateway 25. Each gateway provides a wired or wireless connection to user devices, e.g., the Wi-Fi gateway 20 is shown connected to a Wi-Fi access point (AP) 21, and the Wi-Fi AP 21 is wirelessly connected to a tablet computing device 35. The Bluetooth gateway 24 is connected to Bluetooth AP 23 and the Bluetooth AP 23 is wireless connected to a laptop computing device 37. Additionally, the NFC gateway 25 is connected to a NFC AP 27, and the NFC AP 27 is wirelessly connected to a smartphone 28. As also shown in FIG. 1, and discussed further below, a device 40 may be paired directly with a cellular access point, e.g., tower 17, as is known, for communications with a network 14.

The head unit 22 is also connected to one or more broadband connections to allow the head unit 22 to connect to external networks, e.g., a network 14. The network 14 connection can be a wireless data broadband connection, e.g., a cellular data network connection 16, a mobile high speed radio connection 32 and/or a satellite connection 18. For example, the head unit 22 has a wireless communication link established between the cellular data network 16 and a cell tower base station 17. The cell tower base station 17 is connected to the network 14 and may provide access to the Internet with a subscription service provided by a cellular service provider, as is known. Another broadband connection may utilize radio waves or modulated laser light waves to establish communications between the mobile high speed radio connection 32 and the network 14 using a radio communication tower base station 33 to relay data. Yet further alternatively or additionally, the satellite connection 18 can provide the broadband connectivity. For example, the satellite connection 18 is linked to a satellite antenna 19 and the satellite antenna 19, and is wirelessly connected to a satellite 29. The satellite 29 is further wirelessly connected to a ground station 39 and to the network 14. In non-vehicular systems or in stationary situations, there may be a wired connection to the Internet.

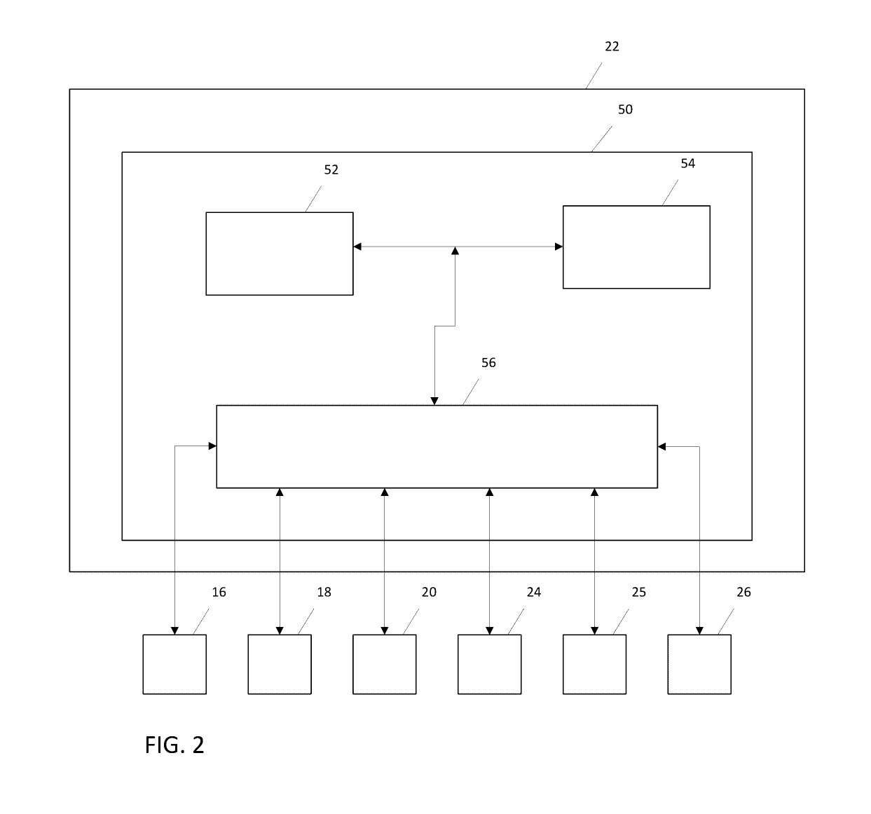

With reference to FIG. 2, the head unit 22 includes a computer 50 that generally includes a processor 52 and a memory 54, the memory 54 including one or more forms of computer-readable media, and further stores instructions executable by the processor 52 for performing various operations, including as disclosed herein. The processor 52 executes such instructions and can use an input/output (I/O) interface 56 to select and control the gateways, e.g., the Wi-Fi gateway 20 or the broadband connections, such as the cellular data network connection 16. The memory 54 of the computer 50 may also store configuration information regarding the gateways and broadband connection types.

A USB (universal serial bus) device, e.g., a USB memory dongle 31, can be inserted into the USB gateway 26 to provide data into and out of the head unit 22, e.g., to update firmware of the head unit 22, provide video or audio data or the like to be played on the vehicle's entertainment system, etc.

The mobile device 40 is shown paired with the cell tower base station 17 for network 14 access. Most wireless mobile devices, as is known, typically favor Wi-Fi connectivity over the wireless mobile device's 40 cellular data access, and will have a software connection manager program running on the mobile device 40 that switches to Wi-Fi connectivity when available instead of using cellular data, with the intent to save money and/or obtain faster higher data rates. However, the head unit 22 broadband connection type may not be as fast and/or as reliable, as the mobile device's 40 cellular data access. In other words, a problem occurs when the mobile device 40 automatically switches to Wi-Fi connectivity without knowing the Wi-Fi connection type to the network 14, which can be slower and less reliable.

For example, an erroneous assumption when mobile devices 40 automatically switch to a Wi-Fi connection is that the access points are stationary and will have a wired connection to the network 14 and will always have a high speed connection to the network 14. In a vehicle, especially a vehicle in motion, there is a likelihood that the vehicle's broadband connection's characteristics will change. For example, the vehicle may be moving in a location where its cellular broadband connection changes from LTE to 3G. LTE, an acronym for Long-Term Evolution, commonly marketed as 4G LTE, is a standard for wireless communication of high-speed data for mobile phones and data terminals. LTE can provide peak download rates up to 299.6 Mbit/s and upload rates up to 75.4 Mbit/s. 3G is the short form of third generation, is the third generation of mobile telecommunications technology. 3G can provide download speed up to 4 Mbits/s and upload speeds of 384 Kbits/s.

In this example, if a mobile device 40 is connected to the vehicle's head unit 22, the data rate typically will dramatically decrease due to the LTE to 3G transition. It is possible for the mobile device 40 mobile broadband connection to be faster than the head unit 22. For example, the mobile device 40 may have LTE connectivity while the head unit 22 has switched to 3G, but because the mobile device 40 is connected to the head unit 22 Wi-Fi, the mobile device is “locked” with the vehicle's Wi-Fi. In other words, the mobile device 40 will not be able to benefit from the mobile device's 40 own higher LTE data rates and is “stuck” with 3G via the head unit 22 Wi-Fi.

Alternatively, a moving vehicle's broadband connection may be provided by spotty satellite services and the mobile device 40 will suffer from data drop outs. Therefore, as explained herein, the mobile device 40 can be configured to determine the type of broadband connection that the head unit 22 is offering before connecting and during its connection to the head unit 22.

Disclosed embodiments include the mobile device 40 requesting information about the vehicle's head unit 22 network 14 connectivity characteristics before associating with the head unit 22. To obtain this information, the mobile device 40 first needs to determine if the head unit 22 is capable of Access Network Query Protocol (ANQP) type queries, as are known, and if so, the mobile device 40 may then transmit a Generic Advertisement Service (GAS) type query, also known. In this context, the term “advertisement” means that an access point can broadcast information about the access point and the head units 22 connections to the network 14. Upon receipt of a GAS query from the device 40, the head unit 22 will provide a response. The GAS response includes a plethora of information about the head unit 22 as is known, e.g., the broadband connection type, as well as other metadata.

An alternative to using the ANQP and GAS messaging protocols, a communications device, such as the mobile device 40 may send a probe request message to an access point, such as the Wi-Fi AP 21. The Wi-Fi AP 21 would interpret the probe request and respond with a communication network connection type in a probe response. Additionally, the access point, such as the Wi-Fi AP 21 may transmit in the Wi-Fi AP 21 beacon, the communication network connection type. This would allow the a communications device, such as the mobile device 40 to merely listen for access point beacons with an appropriate communication network connection type and then decide to associate with the Wi-Fi AP 21.

Another communication network connection type query a communications device, such as the mobile device 40 may initially perform, is to first connect to an access point, such as the Wi-Fi AP 21 without performing ANQP type protocol exchanges. The mobile device 40 can later request the communication network connection type via the GAS type query and then can decide if the communication network connection type is acceptable. If the communication network connection type is acceptable, the mobile device 40 will stay connected to the Wi-Fi AP 21. If the communication network connection type is not acceptable, the mobile device can disengage from the Wi-Fi AP 21.

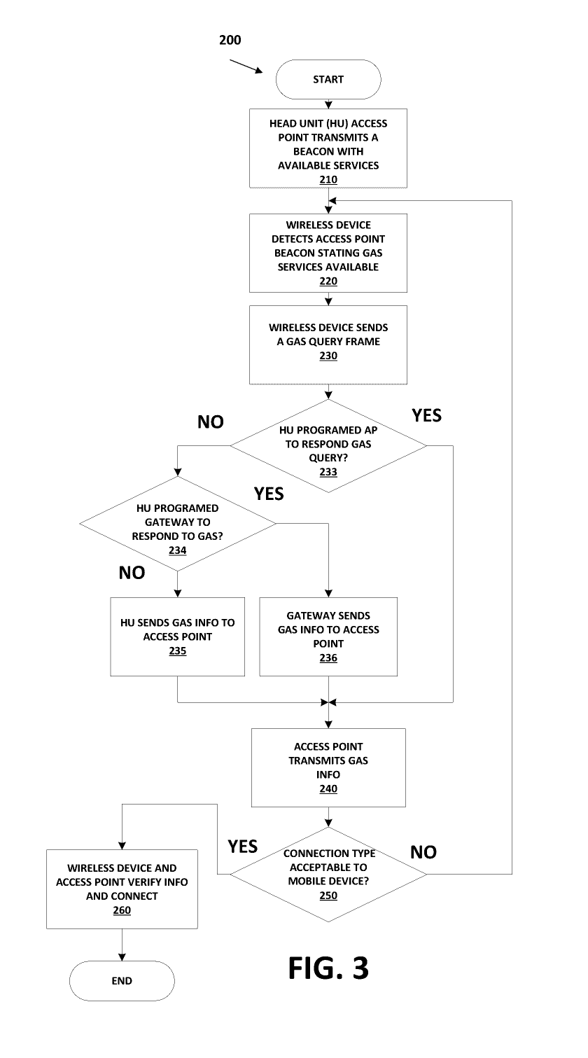

An example of the mobile device 40 connecting to the head unit 22 is illustrated in the process 200 shown in FIG. 3. The Wi-Fi AP 21 broadcasts an advertisement that includes an ANQP frame that indicates ANQP queries are permitted for devices, such as the mobile device 40 or the mobile device 40 which are in a proximate location to the head unit 22, i.e., within radio range in a block 210. The mobile device 40 detects the advertisement in a block 220, and then sends an ANQP GAS request query in a block 230. The query includes requests for the broadband connection type. It will be understood that GAS information may be stored in different parts of the head unit 22, for example the GAS information may be stored in the Wi-Fi AP 21, the Wi-Fi gateway 20 and/or in the head unit 22. Therefore, the computer 50 generally must determine where GAS information is stored, and in a block 233 determines whether the GAS information is stored in the Wi-Fi AP 21.

If the GAS information is stored in the Wi-Fi AP 21 as determined in the block 233, the Wi-Fi AP 21 can directly transmit the GAS information in a block 240 to the mobile device 40. If the GAS information is not is the Wi-Fi AP 21, a further determination will need to made of where the GAS information is stored in a block 234, e.g., in the head unit itself or in the gateway 25. If the head unit 22 has the GAS information, the head unit 22 will send the GAS information to the Wi-Fi AP 21 in a block 235 and the Wi-Fi AP 21 will transmit the GAS information in a block 240. Alternatively, if the Wi-Fi gateway 20 has the GAS information, the Wi-Fi gateway 20 will pass the information to the Wi-Fi AP 21 in a block 236 and the Wi-Fi AP 21 will transmit the GAS information in the block 240.

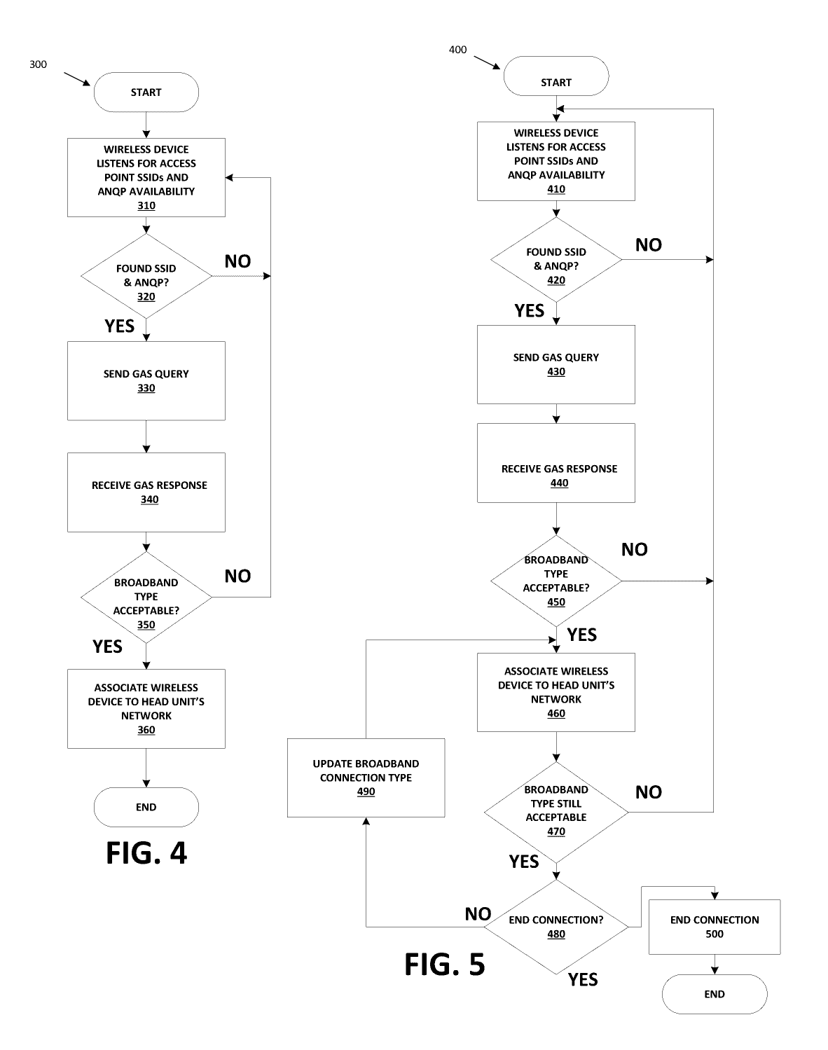

The mobile device 40 receives and evaluates the GAS response in a block 250 mobile device 40 and, decides whether to establish a link to the network 14 via the head unit 22 based on the evaluation of a broadband connection type mobile device 40. An example process for the device 40 to perform this evaluation is discussed below with respect to the process 300 illustrated in FIG. 4.

The process 200 ends following the block 250 if the device 40 decides not to join the head unit 22. Otherwise, the process proceeds to a block 260, in which the device 40 joins the head unit 14, i.e., establish a link to the network 14 via the head unit 22, e.g., in a known manner. Following the block 260, the process 200 ends. As should be apparent from this disclosure, including the foregoing description of the process 200, it is advantageously made possible for the mobile device 40 to be provided with, and to evaluate, a broadband connection type provided by the head unit 22 before connecting to the head unit 22.

With respect to the connection established in the block 260, in an embodiment, the head unit 22 computer 50 may determine if the mobile device 40 is allowed to connect to the head unit 22. This may be accomplished by the processor 52 doing a look-up in the memory 54 to see if the mobile device 40 is white or black listed. Whitelisting is a list or compilation identifying mobile entities that are accepted, recognized, or privileged for the head unit 22. Whereas blacklisting is a list or register of mobile entities are denied a particular privilege, service, mobility or access to the head unit 22. The head unit 22 computer 50 may also determine if the mobile device 40 is permitted to connect to the network 14 of the head unit 22.

An example process for a device 40 mobile device 40 to evaluate the head unit 22 broadband connection type is illustrated in the process 300, illustrated in FIG. 4. When in proximity to, i.e., within wireless communications range of, the head unit 22, the mobile device 40 listens for access point SSIDs that are ANQP capable in a block 310. Once the mobile device 40 detects an SSID, the mobile device 40 will also determine if the ANQP of the access point can respond to the GAS query in a block 320. If the access point cannot respond to a GAS query, the mobile device 40 will return to searching in the block 310.

When the access point can respond to a GAS query, the mobile device 40 sends the GAS query in a block 330 and the mobile device 40 receives the GAS response in a block 340. The mobile device 40 will then analyze the GAS response to determine the broadband connection type of the head unit 22. For example, the broadband connection type may be cellular, satellite or a radio link and the mobile device 40 will determine if the broadband connection type is the type the mobile device 40 wishes to utilize in a block 350. If the broadband connection type is not the type the mobile device 40 wishes to utilize, the mobile device 40 will return to searching for SSIDs and ANQP in a block 310. If the broadband type is the type the mobile device 40 wishes to utilize, the mobile device 40 sends an acknowledgement message 28 to the access point and then associates with the head unit 22 in a block 360. In general, criteria used by the mobile device 40 for determining whether to associate with the head unit 22 may include a connection speed associated with a connection type. That is, relatively faster connection types may be selected, whereas relatively slower connection types may not be selected. For example, the device 40 could be programmed to connect to the head unit 22 if it provides an LTE broadband connection, but not if it provides a 3G connection. Following the block 360, the process 300 ends.

An example of the mobile device 40 procedure for an ongoing evaluation of the head unit 22 broadband connection type while the mobile device 40 is connected to the head unit 22 is illustrated in the process 400, as shown in FIG. 5. That is, once a connection to the head unit 22 is established, as described above with respect to the process 200, the mobile device 40 in a vehicle may continue to evaluate the broadband connection being provided via the head unit 22. The blocks 410-460 are each similar, respectively, to the blocks 310-360, described above, which descriptions thus need not be repeated.

Following the block 460, the mobile device 40 can, e.g., within a predetermined time after the connection with the head unit 22, will determine if the connection type is still acceptable in a block 470. If the connection type is still acceptable, the mobile device 40 will then check for an end of connection in a block 480. If it is not the end of connection, the mobile device 40 later send an additional request to obtain an update of the communication network connection type while the mobile device 40 is connected to the head unit 22 in a block 490 and return to the block 470. For example, the broadband connection type may have changed from cellular to satellite as the vehicle moves. The mobile device 40 will decide if the broadband type is the type the mobile device 40 wishes to utilize in the block 470, e.g., in a manner described above; if so, the smartphone will stay connected to the head unit 22 and proceed to the block 480 and check for the end of communication in the block 480. If the broadband type is not the type the mobile device 40 wishes to utilize, the mobile device 40 will return to looking for SSIDs and ANQPs in the block 410. If the mobile device 40 is finished connecting to the head unit 22, the end of connection in the block 480 answer will be yes, and the mobile device 40 can end the session and disconnect from the head unit 22 in a block 500.

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, C#, Visual Basic, Java Script, Perl, HTML, Python, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system comprising a computer in a vehicle communication head unit that is fixedly installed in the vehicle, the computer being configured to connect to a communications network external to the vehicle, and further configured to:
broadcast a wireless advertisement message;
receive a communication network connection type request from a wireless device;
access a vehicle communication head unit profile, including a communication network connection type to an external network;
notify the wireless device of the communication network connection type;
receive a notification message from the wireless device that the communication network connection type meets a criteria of the wireless device; and
initiate a wireless data communication session with the wireless device.

2. The system of claim 1, wherein the computer is configured to connect the vehicle communication head unit to the external network via at least one of a cellular data network, a satellite network and a high speed radio network.

3. The system of claim 1, wherein the external network is the Internet.

4. The system of claim 1, wherein the computer is configured to verify that the wireless device is permitted to access the vehicle communication head unit.

5. The system of claim 1, wherein the computer is configured to verify that the wireless device is permitted to access the external network through the vehicle communication head unit.

6. The system of claim 1, wherein the computer is configured to connect the vehicle communication head unit to the wireless device via at least one of a Wi-Fi Gateway, a Bluetooth gateway, and a near field communication gateway.

7. The system of claim 1, wherein the computer is configured to receive an additional request from the wireless device for an update of the communication network connection type while the wireless device is engaged with the vehicle communication head unit, and notify the wireless device the communication network connection type.

8. The system of claim 1, wherein the computer is configured to send the communication network connection type in the advertisement message broadcast.

9. A method implemented in a computer in a vehicle communication head unit that is fixedly installed in the vehicle, the computer being configured to connect to a communications network, the method comprising:
broadcasting a wireless advertisement message;
receiving a communication network connection type request from a wireless device;
accessing a vehicle communication head unit profile, including a communication network connection type to an external network;
notifying the wireless device of the communication network connection type;
receiving a notification message from the wireless device that the communication network connection type meets a criteria of the wireless device; and
initiating a wireless data communication session with the wireless device.

10. The method of claim 9, further comprising connecting the vehicle communication head unit to the external network via at least one of a cellular data network, a satellite network and a high speed radio network.

11. The method of claim 9, wherein the external network is the Internet.

12. The method of claim 9, further comprising connecting the vehicle communication head unit to at least one of a Wi-Fi Gateway, a Bluetooth gateway, and a near field communication gateway.

13. The method of claim 12, further comprising connecting the wireless device via at least one of a Wi-Fi Gateway, the Bluetooth gateway, and the near field communication gateway.

14. The method of claim 9, further comprising verifying that the wireless device is permitted to access the vehicle communication head unit.

15. The method of claim 9, wherein the communication network connection type is in the wireless advertisement message broadcast.

16. The method of claim 9, further comprising;
receiving an additional request from the wireless device for an update of the communication network connection type while the wireless device is engaged with the vehicle communication head unit; and
notifying the wireless device the communication network connection type.

17. A system comprising a computer in a mobile device, the computer programmed to connect to a vehicle communication head unit that is fixedly installed in the vehicle, and further configured to:
listen for an advertisement message broadcast;
send a communication network connection type query requesting a communication network connection type;
receive the communication network connection type;
verify the communication network connection type; and
initiate a wireless data communication session with the head unit.

18. The system of claim 17, wherein the user device sends a communication network connection type query before listening for the advertisement message broadcast.

19. The system of claim 17, wherein the communication network connection type is in the wireless advertisement message broadcast.

20. The system of claim 17, wherein wireless device is configured to connect the head unit of the vehicle via at least one of a Wi-Fi Gateway, a Bluetooth gateway, and a near field communication gateway.
